(19) United States
(12) Patent Application Publication
(10) Pub. No.: US 2013/0133509 A1
(43) Pub. Date: May 30, 2013

(54) Modular Emergency Stretcher System

(71) Applicant: BCB INTERNATIONAL LTD., Cardiff (GB)

(72) Inventors: Matthew Searle, Somerset (GB); Christopher Mark Lewis, Rhondda Cynon Taff (GB); William Mark Hocking, Cardiff (GB); Terry Ross, Angus (GB); Ian Ross, Angus (GB)

(73) Assignee: BCB INTERNATIONAL LTD., Cardiff (GB)

(21) Appl. No.: 13/683,714

(22) Filed: Nov. 21, 2012

(30) Foreign Application Priority Data
Nov. 25, 2011 (GB) 1120407.0

(51) Int. Cl. F41H 1/02; A61G 1/01

(52) U.S. Cl. CPC F41H 1/02; A61G 1/01
USPC 89/36.05; 5/627

(57) ABSTRACT

A modular stretcher system includes a pouch having a releasable outer cover and an inner surface, and a stretcher comprised from a lightweight sheet material and stored within the pouch, wherein the stretcher is accessible upon release of the cover, and wherein the stretcher further includes at least two integrated load-bearing system fixings that engage the lightweight sheet and extend through the inner surface. The modular stretcher system may also be incorporated within a protective anti-ballistic jacket.

### BACKGROUND OF THE INVENTION

This invention relates, in general, to stretchers for carrying injured people and is especially, but not exclusively, applicable to person-specific stretchers for soldiers and other security personnel deployed in theatres of war. More particularly, the invention relates to a modular stretcher component for attachment and integration into a modular-load bearing system.

### SUMMARY OF THE PRIOR ART

Serious personal injury is an occupational hazard for armed service personnel. Indeed, irrespective of their wearing of body armour (such as bullet-proof vests at the like), serious trauma can still be sustained from shrapnel, bullets and bombs blasts.

At the present time, a team of men in a hostile environment will be provided with a nominated stretcher carrier who will be responsible for carrying a pre-packed, lightweight stretcher (typically made from a nylon sheet having carry handles attached on either side at the top middle and bottom of the stretcher). As will now be understood, such stretchers are little more than sheets of material on which an injured servicemen is placed and then evacuated the treatment. Emergency field stretches are not designed to be either comfortable or necessarily the most ergonomic for weight distribution, but rather are entirely practical and fit for purpose only.

In the event that someone is injured, the likelihood is that the stretcher will actually not be with the individual (but rather the assigned ‘medic’), so recovery of the injured soldier is immediately compromised. Furthermore, with severe trauma, the injured soldier may be bleeding profusely and potentially have large open wounds that are susceptible to the ingress of dirt and other foreign objects (notwithstanding the likely presence of the initial shrapnel or bullet that caused the wound).

Assuming that a stretcher is available and that the injured soldier can eventually be man-handled onto the stretcher (which is no easy task given that blood and guts are slippery), there is then the problem of physically evacuating the injured soldier to a safe area for treatment; this is easier than it sounds. Specifically, under fire, stretcher-bearing comrades will need to carry and/or drag the laden stretcher across a terrain strewn with debris, not to mention other hazards from ongoing fighting. Furthermore, it is not beyond the realm of possibility that an injured soldier will be supported by only one or two comrades who will be tasked with safely evacuating the injured soldier and all his kit (bearing in mind most will still be worn) to a treatment area or some form of vehicular transport. And furthermore, the comrades might well have to move the injured soldier on his stretcher whilst moving on their haunches.

It is therefore not unusual for the injured soldier to be literally dropped from their stretcher, and for subsequent difficulties to a rise in trying to reposition or just generally secure (at any time) the injured soldier to the stretcher. For example, the nature of the injury may mean that the injured soldier is flailing their arms around, with such action at firstly affecting any attempts to secure or maintain the soldier on the stretcher. With time, the fabric of the stretcher becomes slippery with human blood and entrails, so any delay brought about by physically resting, taking cover or simply moving the injured soldier in an non-optimum fashion causes increasing handling difficulties for the stretcher-bearers and an increased risk of the injured soldier falling off the stretcher.

Even if one had the benefit of a nearby air ambulance, valuable time is still lost in locating the injured soldier on conventional stretchers and in getting to the air ambulance.

In relation to modern uniform, MOdular Lightweight Load-carrying Equipment (or MOLLE) is a current generation of load-bearing equipment and rucksacks utilized, especially, by the British and US Armies. The MOLLE system's modularity is derived from the use of PALS webbing, i.e. rows of heavy-duty nylon stitched onto the vest. The webbing allows for attachment of various MOLLE-compatible pouches and accessories. This method of attachment is the de facto standard for current modular tactical gear, replacing the click-and-stick system used in the earlier modular vest systems

### SUMMARY OF THE INVENTION

According to a first aspect of the invention there is provided a modular stretcher system comprising: a pouch having a releasable outer cover and an inner surface; a stretcher comprised from a lightweight sheet material, the stretcher stored within the pouch; wherein the stretcher is accessible upon release of the cover, the stretcher further including at least two integrated load-bearing system fixings that engage the lightweight sheet and extend through inner surface.

In another aspect of the invention there is provided a protective anti-ballistic jacket including: an integrated load bearing system on an outer surface thereof; and the modular stretcher system according to any preceding claim, wherein said at least two integrated load-bearing system fixings are coupled to the integrated load bearing system on the outer surface of the jacket.

In a preferred embodiment the integrated load bearing system is a MOLLE system and secure coupling is achieved between the stretcher and the jacket by interleaving webbing straps into a webbing grid.

In a further embodiment each pouch including a half-body stretcher, wherein:

the first pouch includes a half-body stretcher for supporting, at deployment, a head of an injured person; and the second pouch includes a half-body stretcher for supporting, at deployment, a lower torso region of the injured person; wherein the webbing grid of the jacket is between the first pouch and the second pouch, the jacket thereby forming an integral part of the stretcher by supporting, at deployment of the half-body stretchers, a mid-rift section of the injured person.

The half-body stretcher in the first pouch may be coupled to the jacket along an upper edge of webbing straps in the webbing grid only, and the half-body stretcher in the second pouch is coupled to the jacket along a lower edge of webbing straps in the webbing grid only.

Advantageously, the present invention provides a system that is permanently and personally associated with every soldier. Upon injury, the integrated stretcher can be broken out of its storage pouch and is deployed immediately under the back of the injured soldier. At worst, the injured soldier is potentially rolled over onto their side to access the stretcher pouch, which avoids having assisting comrades physically move the injured soldier on to a stretcher. Moreover, by virtue of the fact that the stretcher storage pouch is fixedly coupled onto the vest, body armour or harness (rear or front, as the case may be) and the injured soldier is still wearing the vest, body armour or harness, the injured soldier is intrinsically attached to the stretcher in a fashion that means that he is unlikely to become disconnected from his personal stretcher. Consequently, if during evacuation the stretcher is unfortunately dropped, then the stretcher bearers do not need to worry about having to get the injured person back onto the stretcher before evacuation can continue. Valuable time is saved and the ease of removing the injured soldier to an area for treatment improved.

Beneficially, a preferred embodiment of the present invention may be implemented as a retrofit to existing MOLLE-supporting systems or articles of clothing.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a schematic representation of a typical army-issue jacket, including MOLLE straps for securing kit;

FIG. 2 an outer view of a personal stretcher packed into the deployment pouch, the stretcher and pouch in accordance with preferred embodiments of the present invention;

FIG. 3 is an inner perspective view of the personal stretcher and deployment pouch of FIG. 2;

FIG. 4 shows how the personal stretcher and deployment pouch of FIGS. 2 and 3 is retro-fitted in the typical army-issue jacket of FIG. 1;

FIG. 5 shows an assembled combination of the personal stretcher and deployment pouch of FIGS. 2 and 3 with the typical army-issue jacket of FIG. 1;

FIG. 6 is a plan view of the personal stretcher deployed and shown in relation to an injured person; and

FIG. 7 is a side view of FIG. 6.

### DETAILED DESCRIPTION OF THE PREFERRED EMBODIMENTS

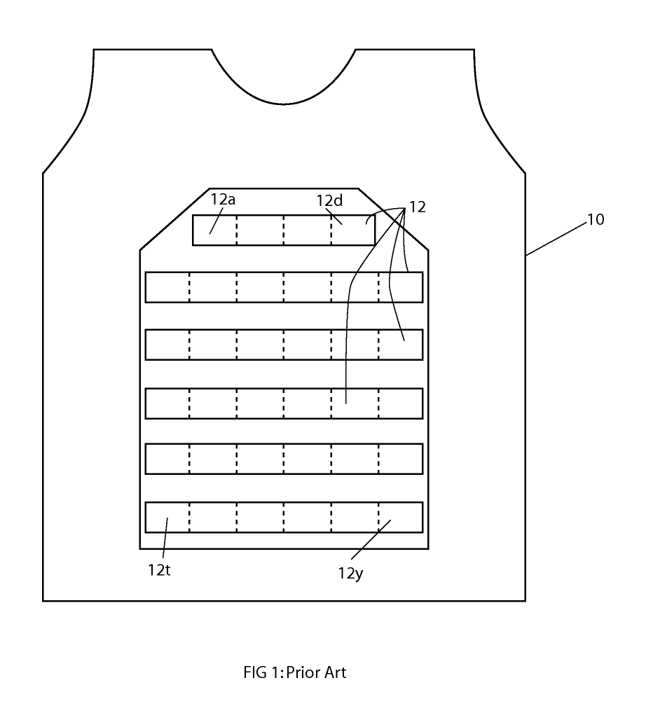

FIG. 1 is a schematic representation of a prior art army jacket 10 incorporating MOLLE straps 12 on an outer surface thereof. As will be appreciated, MOLLE straps 12 are realised by a grid of stitched webbing that provides an array of material channels that can be used as anchor points and ties for modular components having similar MOLLE straps. As will be understood, two MOLLE components can be interconnected using the MOLLE straps to produce an interwoven lattice effect. The MOLLE straps 12 are typically formed over a pocket receptive to rear hard-armour plate.

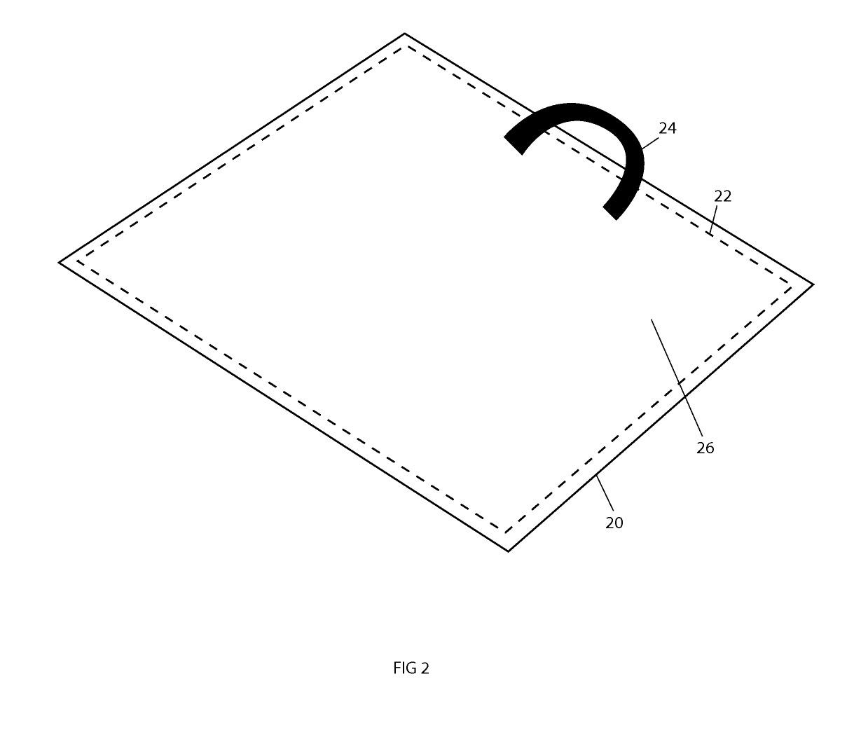

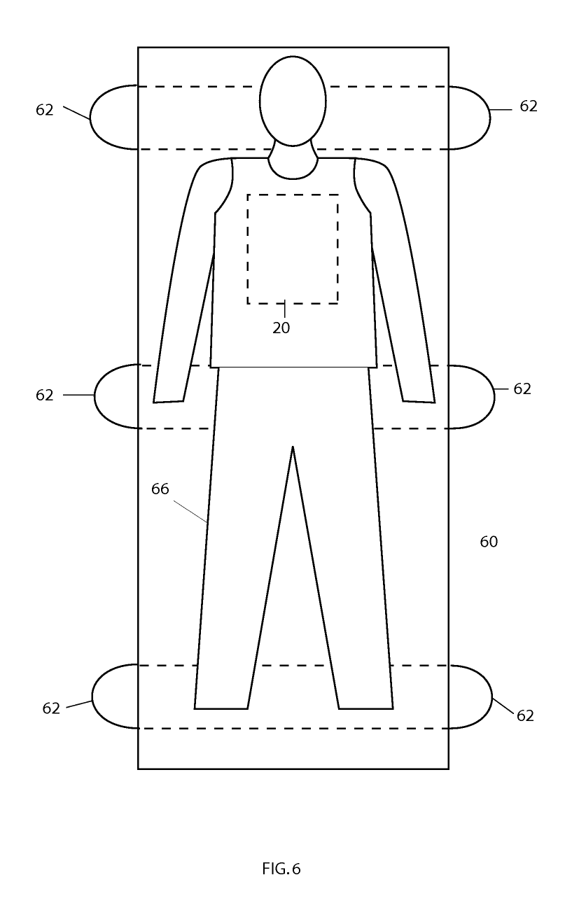

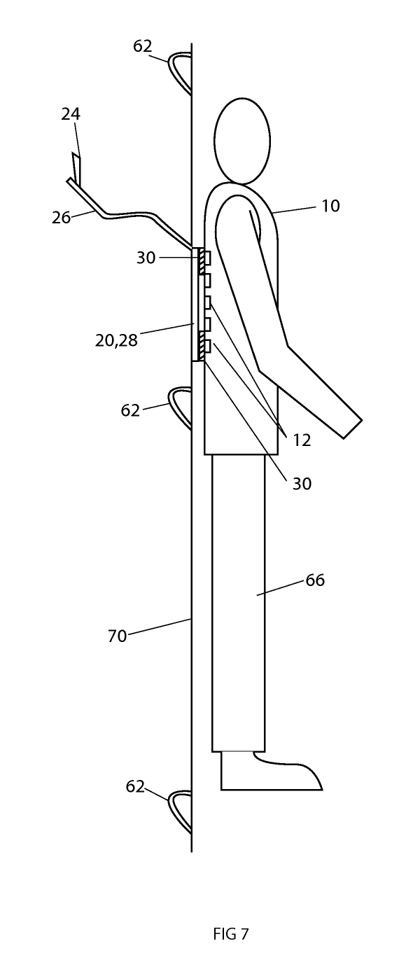

FIG. 2 an outer view of a lightweight, battlefield personal stretcher (see FIG. 6) packed into the deployment pouch 20, the stretcher and pouch 20 in accordance with preferred embodiments of the present invention. Essentially, the pouch is a thin parcel having a rupturable seam 22 and a grab handle 24 secured to a central area 26 bordered by the rupturable seam 22. The pouch houses a compressed and/or folded emergency stretcher. The seam 22 may, for example, be a line of weak stitching; other methods of forming a breakable seam will be understood to the skilled addressee. Preferably, at least an outer surface 26 (if not the whole pouch 20) is water resistant. The pouch 20 may therefore be made from a treated fabric material (whether synthetic or natural), and/or otherwise coated with a plastic protective layer. In one embodiment, the stretcher (reference number 70 of FIG. 7) may be sealed in its pouch 20 so as to maintain some elevated level of cleanliness, if not sterility.

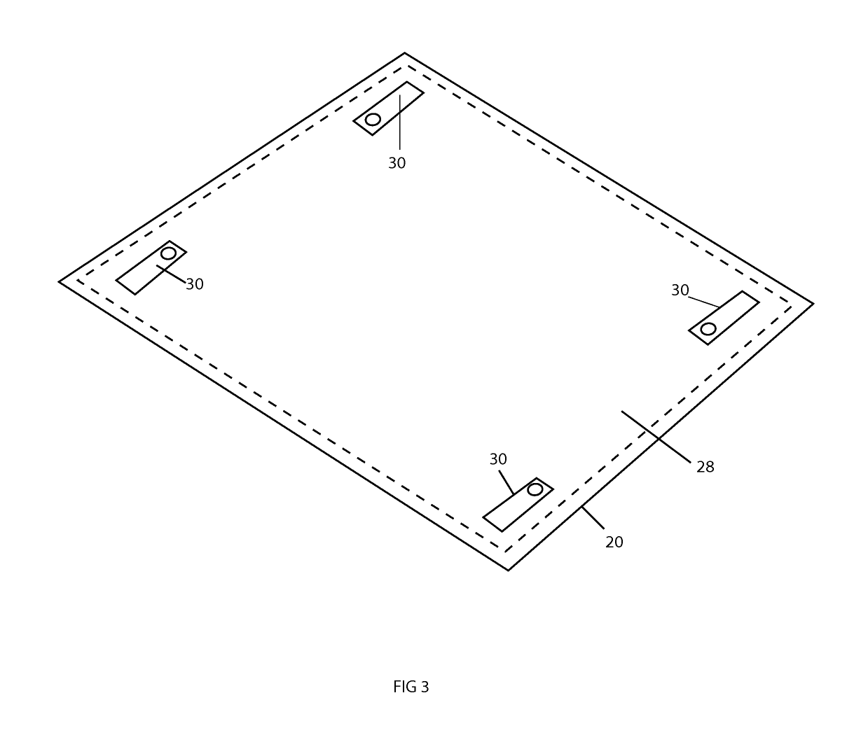

FIG. 3 is an inner perspective view of the personal stretcher and deployment pouch 20 of FIG. 2. Noticeably, the inner perspective view shows an inner surface and a number of (in this case four) strategically positioned MOLLE straps 30 extending through the inner surface. The MOLLE straps 30 physically attach to the stretcher.

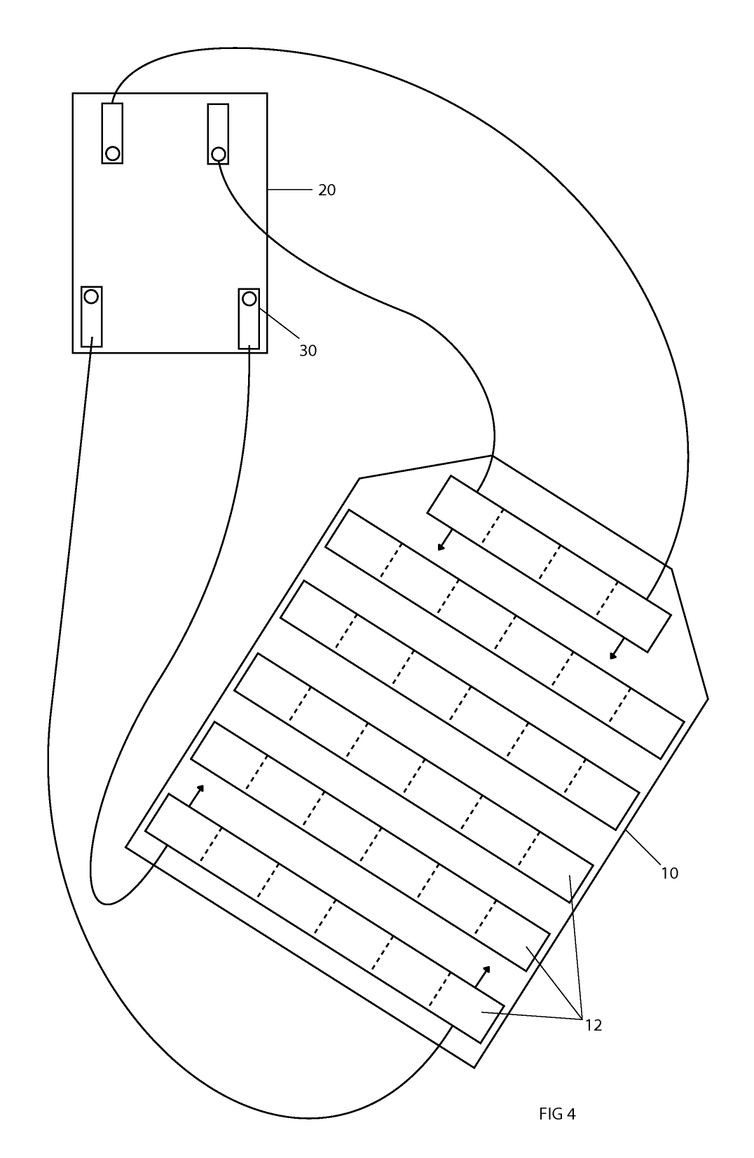

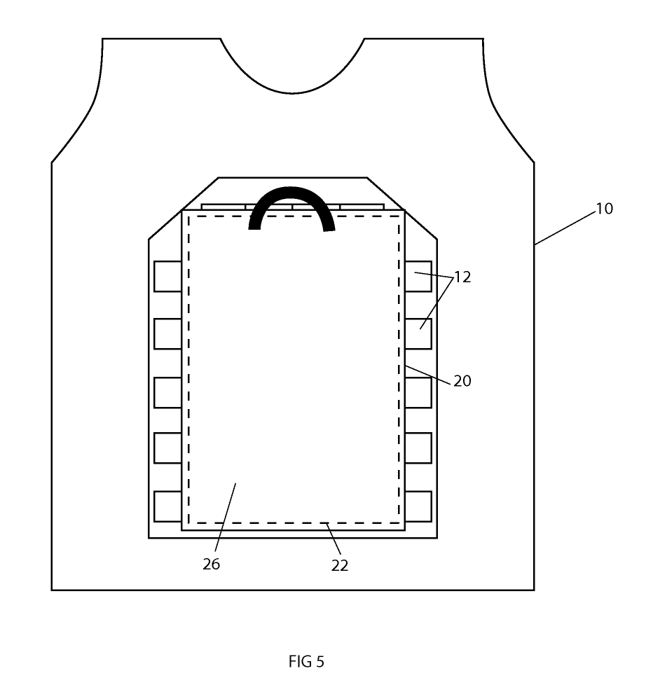

FIG. 4 shows assembly and especially coupling of the deployment pouch 20 to the vest of FIG. 1. As will be understood, MOLLE straps 30 extending through the inner surface engage under corresponding webbing (MOLLE) hooks on the vest, thus permanently securing the stretcher to the vest (or jacket, belt, etc.). FIG. 5 shows the assembled configuration in a retro-fit arrangement, with the grab handle 24 accessible and (preferably) unencumbered. Other MOLLE modules may be attached to the vest. It is noted that, with the requirement for infantry to carry a rucksack containing its own MOLLE system, the pouch and integrated stretcher configuration can be located, in a preferred embodiment, onto the MOLLE system on current army jackets without detracting from overall support of other modular units (that can be attached elsewhere).

The point is that a personalised stretcher (reference numeral 60 of FIG. 6) is now integrated, i.e. secured, into a jacket that is worn by a soldier (or the like); this means that the deployment of the stretcher immediately secures and centrally locates the wearer of the jacket to the stretcher. Further, because of the point of connection, the weight of the wearer is generally distributed in a central fashion and not to one side or towards an upper or lower edge. Load carrying is therefore improved with respect to an injured person 66 lying on the stretcher 60. Conventionally, the stretcher includes integrated carry handles 62 strategically positioned in each corner, and preferably also included mid-way along longest sides of the stretcher 60.

In terms of deployment, the alternative approach to attaching to an army issue jacket (interchangeably referred to as a vest) is to initially roll and store the pre-packed stretcher in its pouch 20 and only clip it to the corners of the MOLLE grid (of the jacket or rucksack) at the point when injury has occurred; this in-field retro-fit means that the casualty is still secure to the stretcher via their vest, harness or belt at the point on evaluation.

Turning to FIG. 7, a full deployment system is shown where the personal stretcher 70 has been released from its pouch 20 following rupturing along weakened seams. The stretcher has been extended outwardly through use of its integrated handles 62. The outer cover 26 and grab handle are therefore superfluous at this time. As can be seen, MOLLE on the injured soldier's jacket maintains a physical connection to the stretcher 70 through interlaced webbing; this is schematically represented by the abutting regions of the MOLLE straps 30 and the MOLLE grid 12 of the jacket 10.

In terms of alternate design options, rather than to have the grab handle attached to the outer cover, the stretcher may be folded and packed such that the handles 62 of stretcher 70 extend through slits in the cover, e.g. an X-shaped corner to corner slice that is weakly resealed or re-sewn. Thereafter, grabbing and pulling directly on the handles 62 of the stretcher 70 ruptures the X-shaped (or centrally, i.e. middle) seam and allows the stretcher to be immediately deployed.

In a fully integrated system, it is contemplated that the integral stretch is located in the rear pouch utilised for back armour plate. Egress would be again controlled by a specific grab handle or the handles of the stretcher, with the stretcher permanently secured into the jacket. MOLLE strap connections could therefore be omitted on the basis that the stretcher was attached securely using a different fixing methodology.

Furthermore, it is also contemplated that the two pouches could, in fact, be provided to serve an upper torso region and a lower abdominal region, with a remaining central portion of the stretcher realized by the reside strength of the jacket. In this respect, a retrofit system would therefore make use of a partial upper stretcher having two MOLLE strap connectors positively engage in only the upper line of webbing loops of FIG. 1, e.g. MOLLE loops 12a and 12d. The partial upper stretcher would again have an easily rupturable seal (such as a weak stitch), with a grab handle to pull a thin cover away from its dedicated pouch. However, to save space, the partial upper stretcher would be rolled into a tight cylinder (or concertina effect) having a lead edge permitting quick deployment, which leading edge would be accessible after rupture of the weak seal. In this way, the partial upper stretcher would still make use of a fixed permanent (in the sense that the MOLLE straps remain interleaved) attachment to the jacket and thus would secure an injured soldier thereto. In a complementary fashion, the lower partial stretcher would also have (at least) two MOLLE strap connectors positively engaged in only the lower line of webbing loops of FIG. 1, e.g. MOLLE loops 12t and 12y. The partial lower stretcher would again have an easily rupturable seal (such as a weak stitch, as previously described), with a grab handle to pull a thin protective cover away from its pouch. Again, to save space, the partial lower stretcher would be rolled into a tight cylinder (or concertina effect) having a lead edge permitting quick deployment, which leading edge would be accessible after rupture of the weak seal. In this way, the partial lower stretcher would still make use of a fixed and permanent (in the sense that the MOLLE straps remain interleaved) attachment to the jacket and thus would secure an injured soldier thereto and support their lower body.

For the avoidance of doubt, whilst the preferred embodiment makes use of MOLLE to implement attachment, other modular system approaches are equally applicable. Consequently, the term MOLLE should not be interpreted in the specification to be limited (unless the specific context demands strict compliance), but rather that it relates to an integrated load-bearing system incorporated into a jacket, harness, belt or other similar article of attire used by a serviceman.

While a first embodiment of the present invention realises a personal stretcher formed into a back pack accessory that can be secured on to MOLLE using, for example, pop studs, it is also contemplated that a personalised stretcher can be integrated directly into a vest, body armour, plate carrier, bullet-proof vest or flak jacket at the point of manufacture. Clearly, first embodiment permits a retrospective approach to providing a personalised integrated stretcher for use, especially, in combat conditions.

It will be understood that unless features in the particular preferred embodiments are expressly identified as incompatible with one another or the surrounding context implies that they are mutually exclusive and not readily combinable in a complementary and/or supportive sense, the totality of this disclosure contemplates and envisions that specific features of those complementary embodiments can be selectively combined to provide one or more comprehensive, but slightly different, technical solutions.

It will, of course, be further appreciated that the above description has been given by way of example only and that modifications in details may be made within the scope of the present invention. For example, whilst the release mechanism is described as a single grab handle at one end of the stretcher enclosure, it is contemplated that the opposing grab handles at the top and bottom could directly pull out the deploy the integrated stretcher.

The invention claimed is:

1. A modular stretcher system comprising:
a pouch having a releasable outer cover and an inner surface;
a stretcher comprised from a lightweight sheet material, the stretcher stored within the pouch;
wherein the stretcher is accessible upon release of the cover, the stretcher further including at least two integrated load-bearing system fixings that engage the lightweight sheet and extend through the inner surface.

2. The modular stretcher system of claim 1, further comprising:
a grab handle attached to the outer cover to effect rupture of a seal, the outer cover forming an integral part of the pouch.

3. The modular stretcher system of claim 1, further comprising:
at least two carry handles securely attached near outer corners of the stretcher.

4. The modular stretcher system of claim 2, wherein the at least two carry handles include at least six carry handles securely attached to the stretcher at three spaced apart locations along each of the longer sides.

5. A protective anti-ballistic jacket comprising:
an integrated load bearing system on an outer surface thereof; and
the modular stretcher system according to claim 1,
wherein the at least two integrated load-bearing system fixings are coupled to the integrated load bearing system on an outer surface of the jacket.

6. The protective anti-ballistic jacket according to claim 5, wherein the integrated load bearing system is a MOLLE system and secure coupling is achieved between the stretcher and the jacket by interleaving webbing straps into a webbing grid.

7. The protective anti-ballistic jacket according to claim 5, further including first and second pouches, each pouch including a half-body stretcher, wherein:
the first pouch includes a half-body stretcher for supporting, at deployment, a head of an injured person; and
the second pouch includes a half-body stretcher for supporting, at deployment, a lower torso region of the injured person;
wherein the webbing grid of the jacket is between the first pouch and the second pouch, the jacket thereby forming an integral part of the stretcher by supporting, at deployment of the half-body stretchers, a mid-rift section of the injured person.

8. The protective anti-ballistic jacket according to claim 7, wherein:
the half-body stretcher in the first pouch is coupled to the jacket along an upper edge of webbing straps in the webbing grid; and
the half-body stretcher in the second pouch is coupled to the jacket along a lower edge of webbing straps in the webbing grid.

9. The protective anti-ballistic jacket according to claim 5, further comprising:
a grab handle attached to the outer cover to effect rupture of a seal, the outer cover forming an integral part of the pouch.

10. The protective anti-ballistic jacket according to claim 5, further comprising:
at least two carry handles securely attached near the outside corners of the stretcher.

11. The protective anti-ballistic jacket according to claim 10, wherein the at least two carry handles include at least six carry handles securely attached to the stretcher at three spaced apart locations along each of the longer sides.
